(19) United States
(12) Patent Application Publication
(10) Pub. No.: US 2024/0011434 A1
(43) Pub. Date: Jan. 11, 2024

(54) ENGINE WITH A COMPRESSOR

(71) Applicant: MTU Aero Engines AG, München (DE)

(72) Inventors: Sergio Elorza Gomez, Karlsfeld (DE); Werner Humhauser, Moosburg (DE); Roland Matzgeller, Hebertshausen (DE)

(73) Assignee: MTU Aero Engines AG, München (DE)

(21) Appl. No.: 18/345,836

(22) Filed: Jun. 30, 2023

(30) Foreign Application Priority Data
Jul. 4, 2022 (DE) 10 2022 116 664.3

(51) Int. Cl. F02C 3/06

(52) U.S. Cl. CPC F02C 3/06

(57) ABSTRACT

The invention is directed to an engine that has a fan, a compressor with a high-pressure compressor, and a combustion chamber. The high-pressure compressor of the engine has a mean stage pressure ratio and an overall pressure ratio formed between the fan and the combustion chamber.

### BACKGROUND OF THE INVENTION

The invention relates to an engine, having a fan, a compressor with a high-pressure compressor, and a combustion chamber, wherein the high-pressure compressor has a mean stage pressure ratio and the engine has an overall pressure ratio between the fan and the combustion chamber.

Efforts are being made for aircraft engines to consume less fuel, to emit fewer emissions, and, in addition, to be quieter as well. To this end, for example, an effort is being made to increase the thermal efficiency of the engine by increasing the overall pressure ratio (OPR) of the compressor in order to reduce fuel consumption. A herewith associated increase in the temperatures in the compressor also demands aerodynamically more slowly rotating compressors, which, in turn, necessitates more compressor stages in order to make possible an adequate lifetime of engine components, in particular for components in a compressor outlet region that is arranged downstream. However, it is known that compressors with conventional stage pressure ratios and stage numbers cannot attain their optimal efficiency at reduced high-pressure compressor rotational speeds.

### SUMMARY OF THE INVENTION

Based on this, the problem of the present invention is to provide an improved engine that has, in particular, an increased overall pressure ratio with a lower load placed on the high-pressure compressor stages. This is achieved in accordance with the present invention.

Proposed for the solution of the problem is an engine, having a fan, a compressor with a high-pressure compressor, and a combustion chamber, wherein the high-pressure compressor has a mean stage pressure ratio V_{S} and the engine has an overall pressure ratio V_{G} between the fan and the combustion chamber. A value of the mean stage pressure ratio V_{S} is hereby smaller than a value increased by one (1) of a k-fold of a value reduced by one (1) of the overall pressure ratio V_{G}. Hereby, k is less than 0.008.

The mean stage pressure ratio V_{S} is expressed in a formula:

V_{S}<1+k*(V_{G}−1)

V_{S} stage pressure ratio

k coefficient

V_{G} overall pressure ratio

For an engine according to the invention, the coefficient k is less than 0.008.

In this way, it is possible to achieve a reduction in a stage load, in particular a mean stage load, or in the mean stage pressure ratio V_{S} for the high-pressure compressor, as a result of which an efficiency advantage, which can entail a reduction in fuel consumption, can be achieved.

The engine can be designed as a turbofan engine and typically has a fan, a combustion chamber, and a turbine. Ambient air, as working fluid, can be sucked in by means of the fan and compressed in a compressor in order to increase the pressure, in particular progressively, in the flow direction. The compressor has a number of compressor stages, which are arranged in the flow direction of the ambient air. Arranged further in the flow direction of the engine after the compressor is the combustion chamber, in which the compressed ambient air is mixed with a fuel and ignited in order to produce combustion gases of high pressure and high temperature. The combustion gases flow from the combustion chamber into the turbine, where they expand and thereby release energy. Owing to the expansion of the combustion gases, a rotor shaft in the turbine section can be driven and, for example, is (also) linked to a generator in order to produce electric energy. Following the turbine, the combustion gases can exit the engine via an exhaust gas outlet.

The compressor has, in particular, a multistage high-pressure compressor and a low-pressure compressor, in particular a multistage low-pressure compressor, that precedes it in the flow direction. The high-pressure compressor hereby has a plurality of compressor stages or high-pressure compressor stages, which are positioned inside of a flow channel of the engine, in particular a flow channel that tapers in the flow direction, or are positioned in the flow of the ambient air or working fluid. The compressor stages hereby exhibit a geometry that is adapted to the flow channel of the engine and tapers in the flow direction in order to achieve a compression of the working fluid. Each of the compressor stages can hereby have a rotor or a rotating blade cascade, which can rotate around an engine axis or rotational axis of the engine, and a fixed stator, which follows it downstream, or a guide vane cascade.

The overall pressure ratio V_{G} of the engine or the overall compression ratio between the fan and the combustion chamber is hereby, in particular, the ratio of a back pressure of the working fluid at a downstream outlet side of the compressor of the engine or at an upstream inlet side of the combustion chamber to a back pressure of the working fluid at an upstream inlet side of the fan or a ratio of a total pressure of the working fluid at an inlet to the combustion chamber to a total pressure of the working fluid at an inlet of the fan. The total pressure is hereby, in particular, the pressure that is adjusted in a flowing medium or in the working fluid at a point of measurement at which the flow speed is reduced isentropically or loss-free to nearly standstill.

The mean stage pressure ratio V_{S} of the high-pressure compressor is a power of the high-pressure compressor pressure ratio (pressure ratio) V_{HDV} of the compressor, where the exponent of the power is the inverse value of a stage number of the high-pressure compressor. This can be represented by means of the following equation G₁:

mean stage pressure ratio V_{S}=pressure ratio V_{HDV}^{1/stage number} G₁:

The stage number is hereby the number of the high-pressure compressor stages of the respective high-pressure compressor. The high-pressure compressor pressure ratio V_{HDV} or the overall pressure ratio V_{HDV} of the high-pressure compressor is hereby, in particular, the ratio of a backpressure of the working fluid at an upstream inlet side and a downstream outlet side of the high-pressure compressor of the compressor or of the engine.

In order to fulfill the condition posed in accordance with the invention, the engine or the high-pressure compressor thereof has to be designed in such a manner that the value of the mean stage pressure ratio V_{S} is smaller than a value increased by one of a k-fold (value) of a value reduced by one of the overall pressure ratio V_{G}. This can be represented by means of the following equation G₂:

mean stage pressure ratio V_{S}<1+k* G₂:

(overall pressure ratio V_{G}−1)

It ensues from this that the coefficient k can specify a slope of the linear function. Accordingly, high-pressure compressors whose stage pressure ratio V_{S} versus an overall pressure ratio V_{G} lies below the given linear function can be regarded as having fulfilled the condition G₂ proposed herein.

The invention is based on, among other things, the idea of increasing the stage number of the high-pressure compressor in comparison to known compressors in order to be able to increase the overall pressure ratio V_{G} of the compressor and, at the same time, to reduce, in particular, a thereby resulting, increased load placed on the high-pressure compressor stages of the compressor. This can result in an efficiency advantage in comparison to known compressors or high-pressure compressors and can lead to a reduction in fuel consumption. In this way, it is possible to reduce an environmental impact due to the operation of an engine that is designed in this manner.

In an embodiment, k is less than 0.0075. If the coefficient k chosen to be less than 0.0075, a further reduced stage load for the high-pressure compressor can be made possible and, at the same time, an increase in the overall pressure ratio can be made possible.

In an embodiment, k is less than 0.007. Through a reduction of the coefficient k to a value less than 0.007, it is possible, in particular, to achieve a further reduction in the load, resulting from operation of the engine, that is placed on the high-pressure stages.

In an embodiment, k is less than 0.0065. The smaller the coefficient k is chosen or the lower is the stage pressure ratio V_{S} in order to fulfill the prespecified criterion of the equation G₂, the lower are the loads placed on the components of the high-pressure compressor stages during operation of the engine.

In an embodiment, k is less than 0.006. If the coefficient k can be chosen in such a way, it is possible, in particular, to reduce further the stage load for individual stages of the high-pressure compressor and/or the total load for the stages, in particular in order to increase a lifetime of the high-pressure compressor components in spite of an increase in the overall pressure ratio V_{G} of the compressor.

In an embodiment, the engine is a geared turbofan. A geared turbofan is, in particular, a turbofan engine that has at least one gear, in particular a reduction gear between a first shaft and/or a second shaft and a fan shaft. In this way, it is possible to lower a rotational speed of the fan and to increase a rotational speed of a turbine and/or of a compressor, as a result of which the respective components can operate in their respective optimal rotational speed range in order to reduce, in particular, consumption values and noise level.

In geared turbofans for aircraft, the fan, in particular at least one fan stage, can be driven via at least one turbine stage, in particular a low-pressure turbine stage, whereby an intervening gear in the form of a planetary gear, for example, reduces the rotational speed of the fan in relation to the at least one turbine stage. Accordingly, the fan and the at least one turbine stage can be operated independently of one another in respectively optimized rotational speed ranges.

In an embodiment, the overall pressure ratio V_{G} is greater than 50, in particular up to 60. A high overall pressure ratio V_{G} can make possible advantages in regard to an efficiency improvement, a fuel consumption reduction, an emission output, and/or a noise emission reduction.

In an embodiment, the high-pressure compressor has at least seven high-pressure compressor stages. In particular, the high-pressure compressor has at least eight, in particular at least nine, in particular at least ten, in particular at least eleven, and in particular at least twelve high-pressure compressor stages. In that the pressure ratio for the high-pressure compressor can be increased depending on a prespecified number of high-pressure compressor stages and, at the same time, when the condition proposed here is fulfilled, a load placed on the high-pressure compressor stages can remain in an uncritical range, it is possible to achieve an increase in the thermal efficiency of an engine according to the invention, without thereby reducing the operational lifetime of the high-pressure compressor components.

### BRIEF DESCRIPTION OF THE DRAWING FIGURES

Further features, advantages, and possible applications of the invention ensue from the following description in conjunction with the figures. In general, it holds that features of the various exemplary aspects and/or embodiments described herein can be combined with one another, provided that this is not clearly excluded in connection with the disclosure.

In the following part of the description, reference is made to the figures, which are shown for highlighting specific aspects and embodiments of the present invention. It is understood that other aspects can also be used and that structural or logical changes in the illustrated embodiments are possible without leaving the scope of the present invention. The following description of the figures is therefore to be understood as being non-limitative. Shown are:

FIG. 1 a schematic illustration of an exemplary engine according to the invention; and

FIG. 2 a diagram of an exemplary mean stage pressure ratio V_{S} versus an overall pressure ratio V_{G} of an engine according to the invention.

### DESCRIPTION OF THE INVENTION

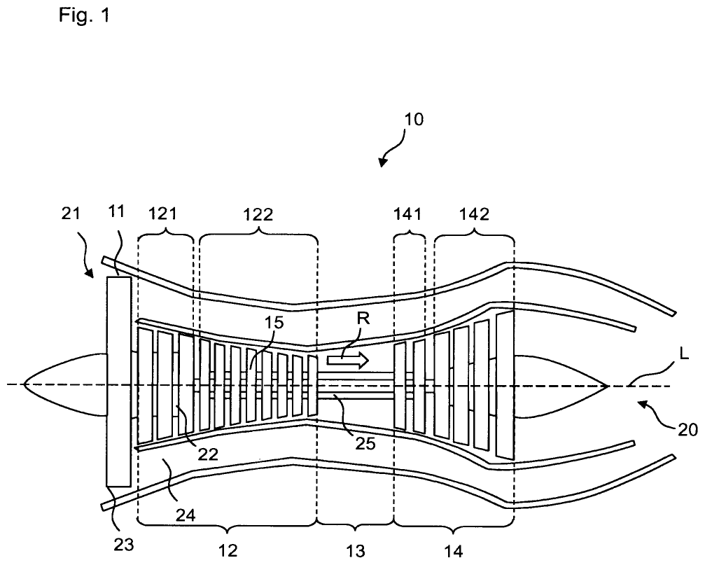

FIG. 1 shows an exemplary illustration of an embodiment of an engine 10 according to the invention in a schematic sectional view.

The engine 10 is designed, by way of example, as a geared turbofan, such as is used in aircraft. Arranged in succession along an engine rotational axis L in the flow direction, the geared turbofan 10 has an air inlet 21, a fan 11 with at least one fan stage, a gear 22, a compressor 12, a combustion chamber 13, a turbine 14, and a nozzle 20. Arranged in succession in the flow direction R, the compressor 12 hereby has a low-pressure compressor 121 and a high-pressure compressor 122. Arranged in succession in the flow direction R, the turbine 14 has a high-pressure turbine 141 and a low-pressure turbine 142. A fan housing 23 surrounds the fan 11 and defines the air inlet 21.

The geared turbofan 10 is set up to accelerate air entering the air inlet 12 as working fluid by means of the fan 11. Two flows of air are thereby produced. A first flow enters the compressor 12 and a second flow of air passes through a secondary flow channel 24.

The low-pressure compressor 121 compresses the entering first flow of air, before it reaches the high-pressure compressor 122, in which a further compression occurs. The compressed air or air flow that exits the high-pressure compressor 122 is conducted into the combustion chamber 13, where it is mixed with fuel and the mixture is then caused to undergo combustion. The hot combustion gases are relaxed in the high-pressure turbine 141 and in the low-pressure turbine 142 with the release of rotational energy to the turbine stages, before they are expelled through the nozzle 20 and thereby afford additional thrust.

The high-pressure turbine 141 and the low-pressure turbine 142 each drive, via shaft apparatuses 25, the high-pressure compressor 122 and the low-pressure compressor 121. A low-pressure shaft drives the fan 11 via the gear 22. The gear 22 is hereby designed as a reduction gear, which reduces the rotational speed of the fan 11 in relation to the low-pressure compressor 121 and the low-pressure turbine 142. The gear 22 can hereby be designed, for example, as a planetary gear.

The high-pressure compressor 122 hereby has a mean stage pressure ratio V_{S} and the engine 10 has an overall pressure ratio V_{G} between the fan 11 and the combustion chamber 13. A value of the mean stage pressure ratio V_{S} is hereby smaller than a value increased by one of a k-fold value of a value reduced by one of the overall pressure ratio V_{G}, with the coefficient k being less than 0.008. The overall pressure ratio V_{G} is a ratio of a total pressure of the working fluid or of the first flow of air at an inlet of the combustion chamber 13 to a total pressure of the working fluid at an inlet of the fan 11. The overall pressure ratio V_{G} of the compressor can hereby be greater than 50, in particular up to 60.

The mean stage pressure ratio V_{S} of the high-pressure compressor 122 is a power of the pressure ratio V_{HDV} of the high-pressure compressor 122, where the exponent of the power is the inverse value of a stage number of the high-pressure compressor 122. The high-pressure compressor 122 of the illustrated embodiment has seven stages 15 or high-pressure compressor stages 15. In accordance herewith, the stage number or the value of the stage number is seven. The pressure ratio V_{HDV} of the high-pressure compressor 122 is the ratio of a backpressure of the first flow of air or of the working fluid at an upstream inlet side of the high-pressure compressor 122 and a downstream outlet side of the high-pressure compressor 122 of the compressor 12 or of the engine 10.

By way of the design of the engine 10 described here, it is possible to increase the stage number of the high-pressure compressor 122 in comparison to known compressors in order to be able to increase the overall pressure ratio V_{G} of the compressor 12 and, at the same time, to be able to minimize an increased load, in particular a thereby resulting increased load, for the high-pressure compressor stages 15 of the compressor 12. To this end, an efficiency advantage in comparison to known compressors or high-pressure compressors can ensue and, in particular, can lead to a reduction in fuel consumption in order to reduce an environmental impact, for example.

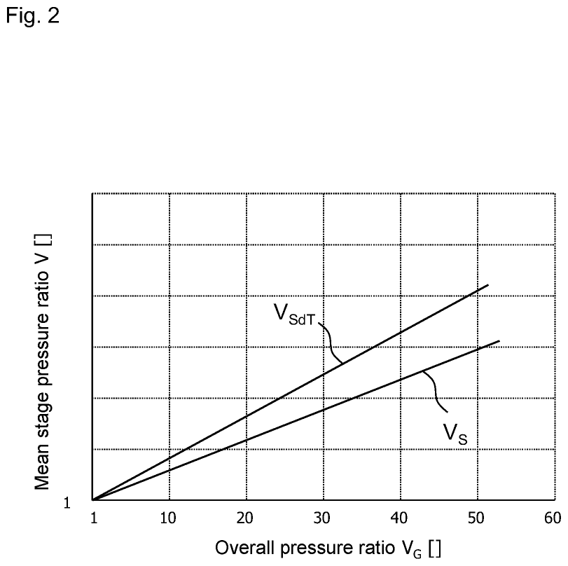

FIG. 2 shows a diagram of an exemplary curve of a mean stage pressure ratio V_{S} of the high-pressure compressor 122 of the engine 10 from FIG. 1 and of an exemplary curve of a mean stage pressure ratio V_{SdT} of an engine known from prior art. The stage pressure ratio V_{S} is hereby plotted on the y axis of the diagram versus an overall pressure ratio V_{G} given on the x axis.

For the exemplary embodiment of the engine 10 described, the following holds:

mean stage pressure ratio V_{S}<1+k*(overall pressure ratio V_{G}−1).

FIG. 2 illustrates the coefficient k as a slope of a linear function for the mean stage pressure ratio V_{S}. Because known high-pressure compressors have a higher mean stage pressure ratio V_{SdT} versus the overall pressure ratio V_{G} or the depiction thereof in the form of a linear function, the stage load for the individual stages and also an average stage load are found to be higher than for an engine 10 that is designed in accordance with an embodiment described herein.

Through a reduction in the coefficient k, it is possible to achieve a reduction, in particular a further reduction, in the load, resulting from operation of the engine 10, that is placed on the high-pressure compressor stages 15. If the mean stage pressure ratio V_{S} is smaller than a value increased by one of the k-fold of the value reduced by one of the overall pressure ratio V_{G} and k is hereby, in particular, less than 0.0075, in particular less than 0.007, in particular less than 0.0065, in particular less than 0.006, it is possible to reduce further a stage load for the high-pressure compressor stages 15 in order to make available an improved engine, in particular an efficiency-improved engine.

1. An engine, having a fan, a compressor with a high-pressure compressor, and a combustion chamber, wherein the high-pressure compressor has a mean stage pressure ratio and the engine has an overall pressure ratio between fan and combustion chamber, wherein a value of the mean stage pressure ratio is smaller than a value increased by one of a k-fold of a value reduced by one of the overall pressure ratio wherein k is less than 0.008.

2. The engine according to claim 1, wherein k is less than 0.0075.

3. The engine according to claim 1, wherein k is less than 0.007.

4. The engine according to claim 1, wherein k is less than 0.0065.

5. The engine according to claim 1, wherein k is less than 0.006.

6. The engine according to claim 1, wherein the engine is a geared turbofan.

7. The engine according to claim 1, wherein the overall pressure ratio is greater than 50.

8. The engine according to claim 1, wherein the high-pressure compressor has at least seven high-pressure compressor stages.
